(19) United States
(12) Patent Application Publication
(10) Pub. No.: US 2022/0093976 A1
(43) Pub. Date: Mar. 24, 2022

(54) APPARATUS FOR RESISTING FLAME OF BATTERY OF ELECTRIC VEHICLE

(71) Applicants: HYUNDAI MOTOR COMPANY, Seoul (KR); KIA CORPORATION, Seoul (KR)

(72) Inventor: Hyunchang KANG, Seoul (KR)

(73) Assignees: HYUNDAI MOTOR COMPANY, Seoul (KR); KIA CORPORATION, Seoul (KR)

(21) Appl. No.: 17/387,739

(22) Filed: Jul. 28, 2021

(30) Foreign Application Priority Data
Sep. 22, 2020 (KR) 10-2020-0122094

(51) Int. Cl. H01M 10/42; H01M 50/143; H01M 50/242

(52) U.S. Cl. CPC H01M 10/4207; H01M 2220/20; H01M 50/242; H01M 50/143

(57) ABSTRACT

An apparatus for resisting flame of a battery of an electric vehicle includes: a battery module including a plurality of battery cells; and a flame resisting sheet provided between the plurality of battery cells.

### CROSS-REFERENCE TO RELATED APPLICATION

This application claims priority to and the benefit of Korean Patent Application No. 10-2020-0122094, filed on Sep. 22, 2020, the entire contents of which are incorporated herein by reference.

### FIELD

The present disclosure relates to a flame retardant device for a battery of an electric vehicle.

### BACKGROUND

The statements in this section merely provide background information related to the present disclosure and may not constitute prior art.

An electric vehicle is a vehicle that uses a battery engine operated by electrical energy outputted from a battery.

Since such an electric vehicle uses a battery in which a plurality of secondary cells capable of being charged and discharged are formed as a single pack as a main power source, it has the advantage of no emissions and very little noise.

In addition, a hybrid vehicle is a vehicle that uses two or more power sources to propel the vehicle, for example, an engine powered by fuel and an electric motor powered by a battery.

In the vehicle using electrical energy as described above, since performance of the battery directly affects performance of the vehicle, a battery management system is required to efficiently manage charging and discharging of each battery cell by measuring a voltage of each battery cell, and a voltage and current of an entire battery, and to ensure maximum performance of the battery cell by determining whether each battery cell is degraded.

Recently, the use of lithium-ion batteries in such electric vehicles is increasing. The lithium-ion battery is a type of rechargeable battery, and has a multilayer structure including a positive electrode activated by various mixed oxides or olivine, a negative electrode activated by a specific carbon, and a separator immersed in an organic electrolyte.

In a normal operation state thereof, electrical energy is converted into chemical energy and stored during charging, and the stored chemical energy is converted into electrical energy during discharging. In more detail, during charging, lithium in the positive electrode is ionized to move layer by layer toward the negative electrode. During discharging, ions move to the positive electrode to return to their original compound.

In such a lithium-ion battery, a state known as self-heating may occur in extreme situations of overvoltage, overcurrent, or overtemperature. Due to the self-heating, the lithium-ion battery may enter a thermal runaway state. The self-heating means a state in which a temperature inside a battery cell rises due to an electrical-chemical structure inside the battery cell.

When the thermal runaway occurs inside a battery module, it may cause very extreme and severe damage. When the thermal runaway occurs, a very little amount of oxygen may be generated, and an internal temperature may rise to 800 degrees Celsius or more.

When such a situation occurs, a fire may occur inside the vehicle, excessive gas may be generated, or a case in which a lithium-ion battery cell is accommodated may be destroyed.

Particularly, when the thermal runaway occurs in one battery cell in the battery module, high temperature heat or flame propagates to adjacent battery cells, and accordingly, flame may rapidly occur in all battery cells of the battery module.

Due to the thermal runaway occurring in one battery cell, since the thermal runaway and the resulting fire rapidly propagate to all the battery cells of the battery module, a problem that the occupants in the vehicle may not secure time to evacuate may occur.

The above information disclosed in this Background section is only for enhancement of understanding of the background of the present disclosure, and therefore it may contain information that does not form the prior art that is already known to a person of ordinary skill in the art.

### SUMMARY

The present disclosure provides an apparatus for resisting flame of a battery of an electric vehicle that may reduce or minimize a time for high-temperature heat and flames due to a thermal runaway occurring in one of a plurality of battery cells of a battery module mounted in an electric vehicle to propagate to adjacent battery cells.

In an exemplary form of the present disclosure, an apparatus for resisting flame of a battery of an electric vehicle includes: a battery module including a plurality of battery cells; and a flame resisting sheet provided between the plurality of battery cells.

The plurality of battery cells may include a plurality of series battery cell assemblies that are adjacent to each other and connected to each other in series, the plurality of series battery cell assemblies may be connected to each other in parallel, and the flame resisting sheet may be respectively provided between the series battery cell assemblies.

The apparatus for resisting the flame of the battery of the electric vehicle may further include an adjustment sheet that is stacked on the flame resisting sheet and prevents a deformation of the battery module due to deformation of the battery cell.

The adjustment sheet may include silicone or urethane.

The flame resisting sheet may contain mica or silicon.

The battery cell may be a pouch type of battery cell, the pouch type of battery cell may include a main body and rounding portions formed at both ends of the main body, and an area of the flame resisting sheet may be formed larger than that of the main body.

The battery cell may be a prismatic type of battery cell, and an area of the flame resisting sheet may be formed larger than that of the prismatic type of battery cell.

A thickness of the flame resisting sheet, when a thermal runaway occurs in one of the battery cells, may be set so that heat quantity transmitted for a predetermined time to a battery cell adjacent to the battery cell in which the thermal runaway occurs is within 50% of battery cell capacity.

The thickness of the flame resisting sheet may be determined based on a heat quantity transmitted from a battery cell in which a thermal runaway occurs to a battery cell adjacent thereto, a thermal conductivity of the flame resisting sheet, a contact area between the battery cell and the flame resisting sheet, and a target flame-resisting delay time.

The thickness of the flame resisting sheet may be determined through an equation of

$$Q = k \frac{A ( {T}_{1} - {T}_{2} )}{l} t ,$$

and in the equation, Q is a heat quantity propagated to adjacent cells, k is a thermal conductivity, A is a contact area between the battery cell and the flame resisting sheet, T1 is a temperature of a battery cell in which a thermal runaway occurs, T2 is a temperature of a battery cell adjacent to a battery cell in which a thermal runaway occurs, t is a flame-resisting delay time, and I is a thickness of a flame resisting sheet.

In another form of the present disclosure, an apparatus for resisting flame of a battery of an electric vehicle includes: a battery module including a plurality of series battery cell assemblies in which a plurality of battery cells are connected in series, wherein the series battery cell assemblies are connected in parallel, and a flame resisting sheet provided between the plurality of series battery cell assemblies.

The flame resisting sheet may contain mica or silicon.

The apparatus for resisting the flame of the battery of the electric vehicle may further include an adjustment sheet that is stacked on the flame resisting sheet and that prevents a deformation of the battery module due to deformation of the battery cell.

The adjustment sheet may include silicone or urethane.

The battery cell may be a pouch type of battery cell, the pouch type of battery cell may include a main body and rounding portions formed at both ends of the main body, and an area of the flame resisting sheet may be formed larger than that of the main body.

The battery cell may be a prismatic type of battery cell, and an area of the flame resisting sheet may be formed larger than that of the prismatic type of battery cell.

A thickness of the flame resisting sheet, when a thermal runaway occurs in one of the battery cells, may be set so that heat quantity transmitted for a predetermined time to a battery cell adjacent to the battery cell in which the thermal runaway occurs is within 50% of battery cell capacity.

The thickness of the flame resisting sheet may be determined based on a heat quantity transmitted from a battery cell in which a thermal runaway occurs to a battery cell adjacent thereto, a thermal conductivity of the flame resisting sheet, a contact area between the battery cell and the flame resisting sheet, and a target flame-resisting delay time.

The thickness of the flame resisting sheet is determined through an equation of

$$Q = k \frac{A ( {T}_{1} - {T}_{2} )}{l} t ,$$

and in the equation, Q is a heat quantity propagated to adjacent cells, k is a thermal conductivity, A is a contact area between the battery cell and the flame resisting sheet, T1 is a temperature of a battery cell in which a thermal runaway occurs, T2 is a temperature of a battery cell adjacent to a battery cell in which a thermal runaway occurs, t is a flame-resisting delay time, and I is a thickness of a flame resisting sheet.

According to the apparatus for resisting flame of the battery of the electric vehicle according to the some forms of the present disclosure as described above, by providing a flame resisting sheet between battery cells, even if thermal runaway occurs in one of a plurality of battery cells of a battery module, it is possible to delay a propagation time of high temperature heat and flames to adjacent battery cells as much as possible.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an exploded perspective view of a battery pack for an electric vehicle according to one form of the present disclosure;

FIG. 2 illustrates a perspective view of a battery module for an electric vehicle according to another form of the present disclosure;

FIG. 3 illustrates a perspective view of a battery cell for an electric vehicle according to an exemplary form of the present disclosure;

FIG. 4 illustrates an exemplary form in which a flame resisting sheet is provided in the battery cell of FIG. 3;

FIG. 5 illustrates another form in which a flame resisting sheet is provided in the battery cell of FIG. 3;

FIG. 6 illustrates an exploded perspective view of a battery cell for an electric vehicle according to another form of the present disclosure;

FIG. 7 illustrates an exemplary form in which a flame resisting sheet is provided in the battery cell of FIG. 6;

FIG. 8 illustrates another form in which a flame resisting sheet is provided in the battery cell of FIG. 6; and

FIG. 9 illustrates a structure in which a flame resisting sheet and an adjustment sheet are stacked according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure will be described more fully hereinafter with reference to the accompanying drawings, in which exemplary forms of the present disclosure are shown. As those skilled in the art would realize, the described forms may be modified in various different ways, all without departing from the spirit or scope of the present disclosure.

In order to clearly describe the present disclosure, parts that are irrelevant to the description are omitted, and identical or similar constituent elements throughout the specification are denoted by the same reference numerals.

In addition, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Hereinafter, an apparatus for resisting flame of a battery of an electric vehicle according to some forms of the present disclosure will be described in detail with reference to the accompanying drawings.

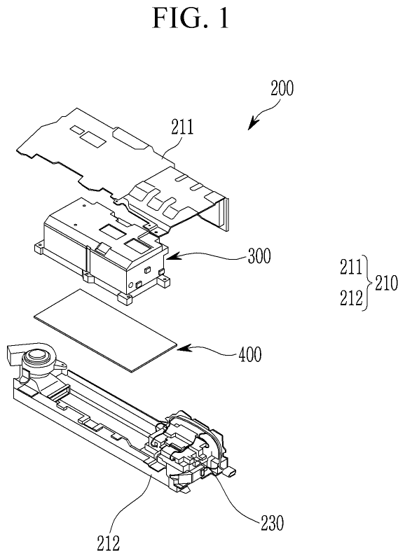

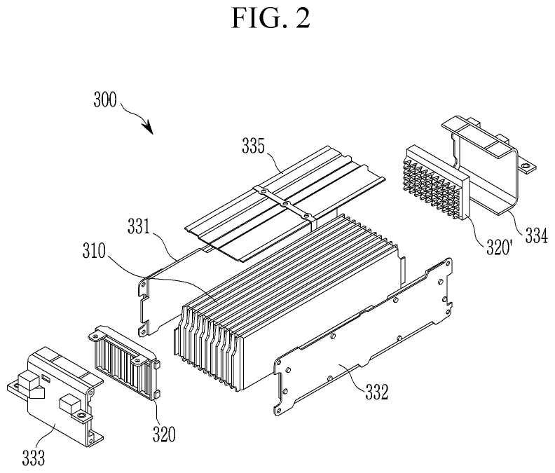

FIG. 1 illustrates an exploded perspective view of a battery pack for an electric vehicle according to an exemplary form of the present disclosure. In addition, FIG. 2 illustrates a perspective view of a battery module for an electric vehicle according to another form of the present disclosure.

As shown in FIG. 1 and FIG. 2, an apparatus for resisting flame of a battery of an electric vehicle includes a battery module 300 including a plurality of battery cells 310, and a battery pack 200 including at least one or more battery modules 300.

That is, the plurality of battery cells 310 may configure the battery module 300, and the plurality of battery modules 300 may configure the battery pack 200. In some forms of the present disclosure, the battery cell 310 may be implemented as a pouch type, a prismatic type, or a cylindrical type.

In one form, the battery pack 200 may include an exterior case 210 forming an exterior, at least one or more battery modules 300 provided inside the exterior case 210, and a battery management system 230.

The exterior case 210 may include an upper case 211 and a lower case 212. The upper case 211 and the lower case 212 are coupled to form the exterior case 210. The exterior case 210 is made of a metal material (for example, carbon steel or aluminum).

At least one or more battery modules 300 and a printed circuit board 320 and 320′ are installed inside the exterior case 210 of the battery pack 200.

The battery module 300 may include a plurality of battery cells 310 and a printed circuit board (PCB) 320 inside a module cover 330 forming an exterior thereof.

The module cover 330 may include a left cover 331, a right cover 332, an upper cover 335, a lower cover, a front cover 333, and a rear cover 334. The left cover 331, the right cover 332, the upper cover 335, the lower cover, the front cover 333, and the rear cover 334 are combined to form the module cover 330, the module cover 330 is provided to surround an outer periphery of the plurality of battery cells 310, and the printed circuit board 320 is provided between the module cover 330 and the battery cell 310.

The plurality of battery cells 310 configuring the battery module 300 are stacked in left and right directions or up and down directions, and the plurality of battery cells 310 may be connected in parallel or in series. The printed circuit boards (PCB) 320 and 320′ are provided at both ends of the plurality of battery cells 310 stacked in the left and right directions or the up and down directions, and each printed circuit board 320 detects a voltage and temperature of each battery cell 310 to transmit them to the battery management system (BMS) 230.

The battery management system 230 receives information of the battery cell 310 detected by various types of sensors (for example, a temperature sensor, a voltage sensor, etc.) through the printed circuit board 320 to determine a situation of the plurality of battery modules 300, and it manages each battery module 300 to be maintained in an optimal state.

Particularly, the battery management system 230 measures the remaining capacity of the battery, maintains a state of charge (SOC) of the battery at an appropriate level, and measures and manages a temperature of the battery.

The plurality of battery cells 310 may be connected in series, and the plurality of battery cells 310 connected in series may be connected in parallel. In this case, the plurality of battery cells 310 adjacent to each other may be connected in series, and the plurality of battery cells 310 connected in series may be connected in parallel to each other.

That is, the battery module 300 may include a series battery cell assembly 390 in which the plurality of battery cells 310 are connected in series, and a plurality of series battery cell assemblies 390 may be connected in parallel to each other.

As such, a nominal voltage outputted from the battery module 300 is determined by the series battery cell assemblies 390 connected in series. In addition, the series battery cell assemblies 390 are connected to each other in parallel to increase an output current of a battery and increase a driving time of the battery.

For example, in the battery applied to the electric vehicle according to the form of the present disclosure, a voltage outputted from each battery cell 310 may be 12 V, and a current outputted therefrom may be 5 A. In this case, as three battery cells respectively outputting 12 V are connected in series, the voltage outputted from the series battery cell assembly 390 becomes 36 V, and thus the nominal voltage outputted from the battery module 300 becomes 36 V. In addition, four series battery cell assemblies 390 respectively configured of three battery cells are connected in parallel, and thus, the current outputted from the battery module 300 becomes 20 A. The configuration of such battery cells is called 3P4S.

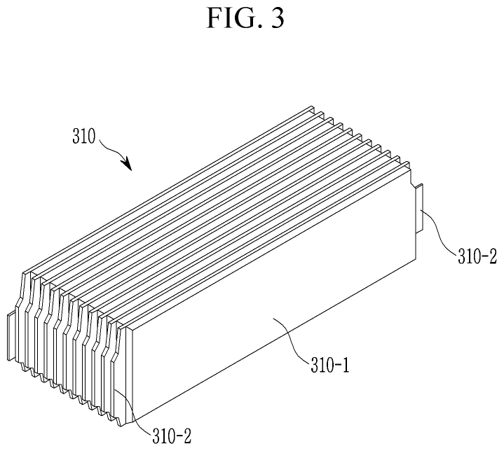

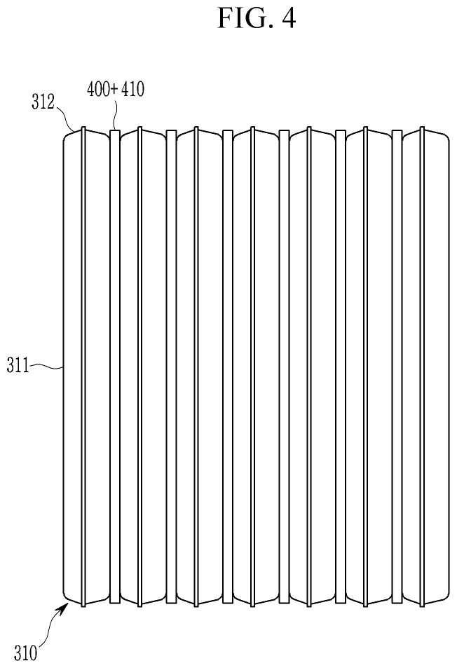

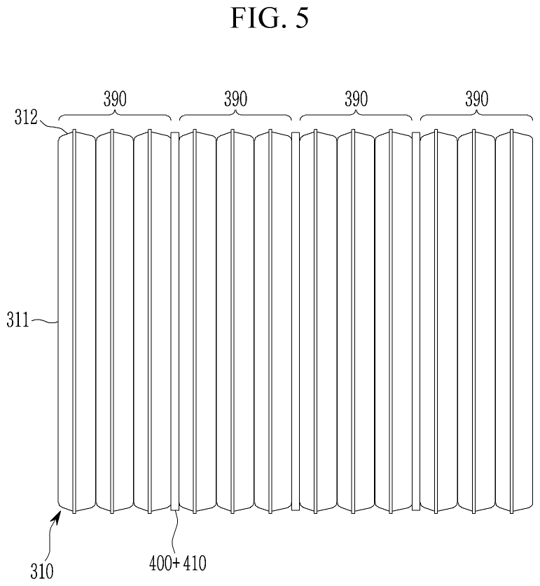

FIG. 3 illustrates a perspective view of a battery cell for an electric vehicle according to an exemplary form of the present disclosure. FIG. 4 illustrates one form in which a flame resisting sheet is provided in the battery cell of FIG. 3. In addition, FIG. 5 illustrates another form in which a flame resisting sheet is provided in the battery cell of FIG. 3. The battery cell 310 shown in FIG. 3 to FIG. 5 has the configuration of a pouch cell type of battery cell.

Referring to FIG. 3 to FIG. 5, the pouch cell type of battery cell 310 may include a pouch main body 310-1 and electrode leads 310-2 provided at both ends of the pouch main body 310-1.

The pouch main body 310-1 may accommodate an electrode assembly (not shown), and may be configured of a multi-layered pouch film including a first resin layer/metal layer/second resin layer. The electrode lead 310-2 is electrically connected to the electrode assembly and electrically connected to the printed circuit board 20.

The pouch main body 310-1 may include a main body 311 formed in a thin approximately hexahedral shape, and a rounding portion 312 formed to be bent at both ends of the main body 311.

When a plurality of pouch cell type of battery cells are stacked, a flame resisting sheet 400 is provided between the plurality of battery cells 310. The flame resisting sheet 400 may be installed between respective battery cells 310 configuring the battery module 300 (see FIG. 4). That is, the flame resisting sheet 400 may be provided between respective battery cells 310 configuring the battery module 300.

In some forms, the flame resisting sheet 400 may be provided between the series battery cell assemblies 390 that are connected in series. As described above, since the flame resisting sheet 400 is provided only between the series battery cell assemblies 390 that are connected in series, it is possible to prevent a volume of the battery module 300 from increasing, and while reducing a manufacturing cost, it is possible to delay the propagation time of high-temperature heat and flames from the battery cells in which the thermal runaway occurs to the adjacent battery cell as much as possible. In one form of the present disclosure, the flame resisting sheet 400 may include mica or silicon (see FIG. 5).

In this case, an area of the flame resisting sheet 400 may be formed larger than an area of the pouch main body 310-1, and in the case of the pouch cell type of battery cell, when the plurality of battery cells 310 are stacked, side surfaces of the pouch bodies of adjacent battery cells contact each other, and the rounding portions 312 of the battery cells do not contact each other. Accordingly, by forming the area of the flame resisting sheet 400 larger than the area of the main body 311, the maximum flame resisting function may be realized through the minimum flame resisting sheet 400. For example, a horizontal length and a vertical length of the flame resisting sheet 400 may be formed to be larger than a horizontal length and a vertical length of the pouch main body 310-1 by a predetermined length (for example, 10 mm), respectively.

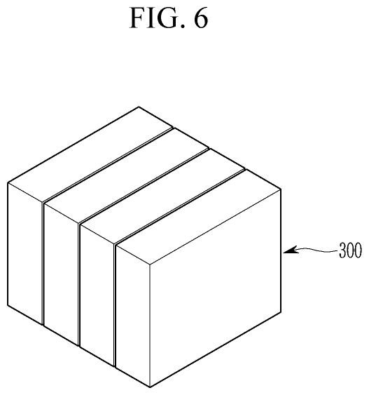

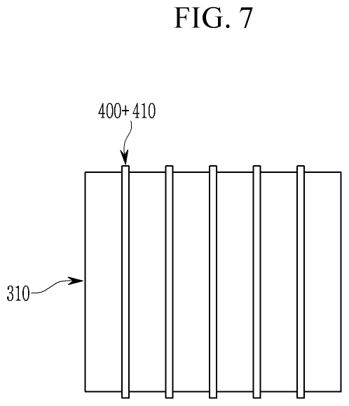

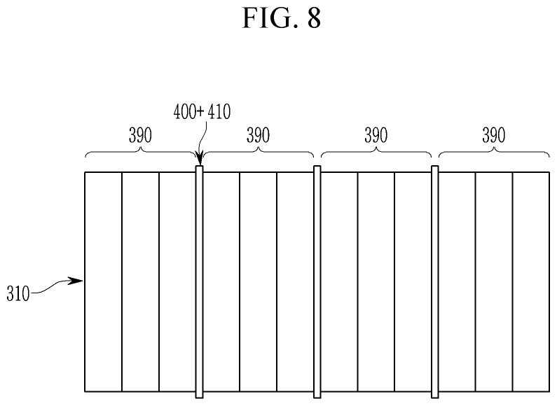

FIG. 6 illustrates an exploded perspective view of a battery cell for an electric vehicle according to another form of the present disclosure. FIG. 7 illustrates one form in which a flame resisting sheet is provided in the battery cell of FIG. 6. In addition, FIG. 8 illustrates another form in which a flame resisting sheet is provided in the battery cell of FIG. 6. The battery cell 310 shown in FIG. 6 to FIG. 8 has the configuration of a prismatic type of battery cell.

Referring to FIG. 6 to FIG. 8, the prismatic type of battery cell 310 is formed in a thin approximately hexahedral shape.

When a plurality of prismatic cell type of battery cells are stacked, the flame resisting sheet 400 is provided between the plurality of battery cells 310. The flame resisting sheet 400 may be installed between respective battery cells 310 configuring the battery module 300 (see FIG. 5). That is, the flame resisting sheet 400 may be provided between respective battery cells 310 configuring the battery module 300.

In some forms, the flame resisting sheet 400 may be provided between the series battery cell assemblies 390 that are connected in series. As described above, since the flame resisting sheet 400 is provided only between the series battery cell assemblies 390 that are connected in series, it is possible to prevent a volume of the battery module 300 from increasing, and while reducing a manufacturing cost, it is possible to delay the propagation time of high-temperature heat and flames from the battery cells in which the thermal runaway occurs to the adjacent battery cell as much as possible. In the form of the present disclosure, the flame resisting sheet 400 may include mica or silicon (see FIG. 8).

In this case, an area of the flame resisting sheet 40 may be formed larger than a side area of the prismatic cell type battery cell 310 in contact with the flame resisting sheet 40. In a case of a battery module of the prismatic type of battery cell, when the plurality of battery cells 310 are stacked, side surfaces of the battery cells adjacent to each other contact each other. Accordingly, by forming the area of the flame resisting sheet 400 larger than that of the battery cell 310, the maximum flame resisting function may be realized through the minimum flame resisting sheet 400. For example, a horizontal length and a vertical length of the flame resisting sheet 400 may be formed to be larger than a horizontal length and a vertical length of the battery cell by a predetermined length (for example, 10 mm), respectively.

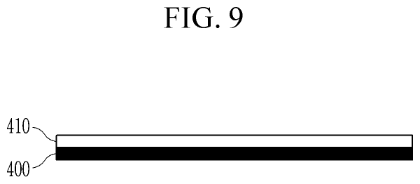

An adjustment sheet 410 for preventing a deformation of the battery module due to deformation of the battery cell may be stacked on the flame resisting sheet 400 (see FIG. 9). Generally, when the battery cell repeats charging and discharging, a volume of the battery cell increases. As described above, when the volume of the battery cell increases, deformation of the battery module occurs. Therefore, by installing the adjustment sheet 410 together with the flame resisting sheet 400 between the battery cells, it is possible to prevent the deformation of the battery module. The adjustment sheet 410 may include silicone or urethane. The flame resisting sheet 400 and the adjustment sheet 410 may be attached to each other through an adhesive or adhesive tape.

The flame resisting sheet 400 may be formed in a shape corresponding to the battery cell 310. The flame resisting sheet 400 may be formed larger than a size of the battery cell 310 in order to increase flame resisting performance. For example, the flame resisting sheet 400 may be formed to be about 5 mm or more larger than an outermost size of the battery cell 310.

The flame resisting sheet 400 may be attached to the side surface of the battery cell 310 through an adhesive or adhesive tape.

Meanwhile, a thickness of the flame resisting sheet 400 according to one form of the present disclosure may be determined through Equation 1.

$$Q = k \frac{A ( {T}_{1} - {T}_{2} )}{l} t \qquad [ Equation 1 ]$$

In Equation 1, Q is a heat quantity (Wh) propagated to adjacent cells, k is a thermal conductivity (W/mK), A is a contact area (m²) between the battery cell and the flame resisting sheet 400, T1 is a temperature (K) of the battery cell in which a thermal runaway occurs, T2 is a temperature (K) of the battery cell adjacent to the battery cell in which a thermal runaway occurs, t is a flame resisting delay time (s), and I is a thickness of the flame resisting sheet 400.

For example, assume that battery cell capacity of each battery cell is 72 Wh and a flame resisting material having a thermal conductivity of 0.062 (W/mK) are used to select the thickness of the flame resisting sheet 400 to obtain a delay effect of 3 minutes.

When the contact area between the battery cell and the flame resisting sheet 400 is 300 mm×100 mm, the temperature of the cell at which the thermal runaway occurs is 600 degrees Celsius, and the temperature of the cell adjacent to the cell at which the thermal runaway occurs is 25 degrees Celsius, through Equation 1, in the case of using the flame resisting sheet 400 having a thickness of 1.5 mm, it can be seen that a heat quantity of 36 Wh (50% of battery cell capacity) is transmitted from the battery cell in which the thermal runaway occurs to the adjacent battery cell for 3 minutes.

As described above for example, the thickness of the flame resisting sheet 400 may be set so that the amount of heat transmitted from the battery cell in which the thermal runaway occurs to the adjacent battery cell for a predetermined time (for example, 3 minutes) may be within 50% of the battery cell capacity.

In this way, the setting of the amount of heat transmitted to the adjacent battery cell for a predetermined time (for example, 3 minutes) to be within 50% of the battery cell capacity is in order for the occupants in the vehicle to recognize that the thermal runaway occurs in the battery and then secure a time to evacuate from the vehicle.

According to the apparatus for resisting flame of the battery of the electric according to the exemplary forms of the present disclosure as described above, by installing the flame resisting sheet 400 between the battery cells, even if the thermal runaway occurs in one of the plurality of battery cells configuring the battery module, it is possible to delay a propagation time of high temperature heat and flames to the adjacent battery cells. Therefore, when the thermal runaway occurs in the battery cell, the propagation of the resulting flame to the vehicle body is delayed as much as possible, thereby securing the maximum time for the occupants of the vehicle to evacuate from the vehicle.

In addition, since the flame resisting sheet 400 is installed only between the plurality of series battery cell assemblies 390 connected in series, it is possible to prevent an increase in the volume of the battery module and reduce the manufacturing cost of the battery module.

While this present disclosure has been described in connection with what is presently considered to be practical forms, it is to be understood that the present disclosure is not limited to the disclosed forms, but, on the contrary, is intended to cover various modifications and equivalent arrangements included within the spirit and scope of the present disclosure.

### DESCRIPTION OF SYMBOLS

200: battery pack

210: exterior case

211: upper case

212: lower case

230: battery management system

300: battery module

310: battery cell

320: printed circuit board

330: module cover

331: left cover

332: right cover

333: front cover

334: rear cover

335: upper cover

390: battery cell assembly

400: flame resisting sheet

410: adjustment sheet

What is claimed is:

1. An apparatus for resisting flame of a battery of an electric vehicle, the apparatus comprising:
a battery module including a plurality of battery cells; and
a flame resisting sheet provided between the plurality of battery cells.

2. The apparatus of claim 1, wherein:
the plurality of battery cells are divided into a plurality of series battery cell assemblies that are adjacent to each other and connected to each other in series, and
the flame resisting sheet is respectively provided between the series battery cell assemblies.

3. The apparatus of claim 1, wherein:
the plurality of battery cells include a plurality of series battery cell assemblies that are adjacent to each other and connected to each other in parallel, and
the flame resisting sheet is respectively provided between the series battery cell assemblies.

4. The apparatus of claim 1, further comprising:
an adjustment sheet stacked on the flame resisting sheet and configured to prevent a deformation of the battery module.

5. The apparatus of claim 4, wherein
the adjustment sheet includes silicone or urethane.

6. The apparatus of claim 4, wherein
the flame resisting sheet includes mica or silicon.

7. The apparatus of claim 1, wherein:
battery cells of the plurality of battery cells are a pouch type,
the pouch type-battery cells each include a main body and rounding portions formed at ends of the main body, and
an area of the flame resisting sheet is greater than an area of the main body.

8. The apparatus of claim 1, wherein:
battery cells of the plurality of battery cells are a prismatic type, and
an area of the flame resisting sheet is greater than a side area of a prismatic type-battery cell in contact with the flame resisting sheet among the prismatic type-battery cells.

9. The apparatus of claim 1, wherein:
a thickness of the flame resisting sheet is configured that,
when a thermal runaway occurs in a battery cell of the plurality of battery cells, heat quantity transmitted for a predetermined time to a battery cell adjacent to the battery cell in which the thermal runaway occurs is within 50% of battery cell capacity.

10. The apparatus of claim 9, wherein:
the thickness of the flame resisting sheet is determined based on a heat quantity transmitted from the battery cell in which the thermal runaway occurs to the adjacent battery cell, a thermal conductivity of the flame resisting sheet, a contact area between the battery cell and the flame resisting sheet, and a target flame-resisting delay time.

11. The apparatus of claim 10, wherein
the thickness of the flame resisting sheet is determined through an equation of
$$Q = k \frac{A ( {T}_{1} - {T}_{2} )}{l} t ,$$
where, Q is a heat quantity propagated to adjacent cells, k is a thermal conductivity, A is a contact area between the battery cell and the flame resisting sheet, T₁ is a temperature of a battery cell in which a thermal runaway occurs, T₂ is a temperature of a battery cell adjacent to a battery cell in which a thermal runaway occurs, t is a flame-resisting delay time, and I is a thickness of a flame resisting sheet.

12. An apparatus for resisting flame of a battery of an electric vehicle, the apparatus comprising:
a battery module including a plurality of series battery cell assemblies in which a plurality of battery cells are connected in series, wherein the plurality of series battery cell assemblies are connected in parallel; and
a flame resisting sheet provided between the plurality of series battery cell assemblies.

13. The apparatus of claim 12, wherein the flame resisting sheet includes mica or silicon.

14. The apparatus of claim 9, further comprising:
an adjustment sheet stacked on the flame resisting sheet and configured to prevent a deformation of the battery module.

15. The apparatus of claim 14, wherein the adjustment sheet includes silicone or urethane.

16. The apparatus of claim 12, wherein:
the plurality of battery cells is a pouch type,
pouch type-battery cells each include a main body and rounding portions formed at ends of the main body, and
an area of the flame resisting sheet is greater than an area of the main body.

17. The apparatus of claim 12, wherein:
the plurality of battery cells is a prismatic type, and
an area of the flame resisting sheet is greater than an area of a prismatic type-battery cell of the prismatic type-battery cells.

18. The apparatus of claim 12, wherein:
a thickness of the flame resisting sheet is configured that ,
when a thermal runaway occurs in a battery cell of the plurality of battery cells, heat quantity transmitted for a predetermined time to a battery cell adjacent to the battery cell in which the thermal runaway occurs is within 50% of battery cell capacity.

19. The apparatus of claim 18, wherein:
the thickness of the flame resisting sheet is determined based on a heat quantity transmitted from the battery cell in which the thermal runaway occurs to the adjacent battery cell, a thermal conductivity of the flame resisting sheet, a contact area between the battery cell and the flame resisting sheet, and a target flame-resisting delay time.

20. The apparatus of claim 19, wherein:
the thickness of the flame resisting sheet is determined through an equation of
$$Q = k \frac{A ( {T}_{1} - {T}_{2} )}{l} t ,$$
where, Q is a heat quantity propagated to adjacent cells, k is a thermal conductivity, A is a contact area between the battery cell and the flame resisting sheet, T₁ is a temperature of a battery cell in which a thermal runaway occurs, T₂ is a temperature of a battery cell adjacent to a battery cell in which a thermal runaway occurs, t is a flame-resisting delay time, and I is a thickness of a flame resisting sheet.
